(19) United States
(12) Patent Application Publication
(10) Pub. No.: US 2025/0296750 A1
(43) Pub. Date: Sep. 25, 2025

(54) STRAP DEVICE

(71) Applicant: Winston Products LLC, Cleveland, OH (US)

(72) Inventor: Logan Henderson, Cuyahoga Falls, OH (US)

(21) Appl. No.: 19/085,409

(22) Filed: Mar. 20, 2025

Related U.S. Application Data
(60) Provisional application No. 63/567,461, filed on Mar. 20, 2024.

(51) Int. Cl. B65D 63/12; F16G 11/02

(52) U.S. Cl. CPC B65D 63/12; F16G 11/02

(57) ABSTRACT

A strap device includes a strap having a first end and a second end. A first end component is coupled to the first end of the strap, and includes a first ring, a hook extending from an outer surface of the first ring, and a projection extending from the outer surface of the first ring. A portion of the projection, a portion of the outer surface of the first ring, and a portion of the outer surface of the hook define a channel. A second end component is coupled to the second end of the strap, and includes a second ring sized such that the second ring can pass through the first ring.

### RELATED APPLICATIONS

This application claims the benefit of U.S. Provisional Patent Application No. 63/567,461, filed Mar. 20, 2024, which is incorporated herein by reference.

### BACKGROUND

Various methods and devices exist for securing items together. However, certain difficulties arise due to the limited features of existing solutions such as straps and twist ties. A more versatile device is desirable.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems described herein can be utilized to provide a strap device having a first end component and a second end component. The first end component can include a first ring having a hook and a protrusion extending therefrom. The second end component can include a second ring having a smaller diameter than the first ring. The strap device can be used to secure one or more items in a variety of configurations. The bendable and resilient nature of the strap provides rigidity and strength while wrapped around one or more objects, while still allowing the strap to bend into different shapes and configurations.

To the accomplishment of the foregoing and related ends, the following description and drawings set forth certain illustrative aspects and implementations. These are indicative of but a few of the various ways in which one or more aspects may be employed. Other aspects, advantages and novel features of the disclosure will become apparent from the following detailed description when considered in conjunction with the drawings.

### BRIEF DESCRIPTION OF THE DRAWINGS

FIG. 1 is a front view of an exemplary strap;

FIG. 2 is an exemplary strap device in a wrapped configuration;

FIG. 3 is an exemplary strap device in a daisy-chained configuration;

FIG. 4A is a front view of a portion of a strap;

FIG. 4B is a cross-sectional view of a strap;

FIG. 4C is a front view of a portion of a strap;

FIG. 4D is a cross-sectional view of a strap;

FIG. 5A is a front view of a first end of the strap device;

FIG. 5B is a left side view of a first end of the strap device;

FIG. 5C is a right side view of a first end of the strap device;

FIG. 5D is a bottom view of a first end of the strap device;

FIG. 5E is a perspective view of a first end of the strap device;

FIG. 5F is a right side view of a first end of the strap device;

FIG. 5G is a cross-sectional view of a first end of the strap device;

FIG. 6A is a front view of a second end of the strap device;

FIG. 6B is a side view of a second end of the strap device;

FIG. 6C is a bottom view of a second end of the strap device;

FIG. 6D is a perspective view of a second end of the strap device;

FIG. 7A is an exploded view of either end of an exemplary strap device;

FIG. 7B is an exploded view of either end of an exemplary strap device;

FIG. 8A is a perspective view of a collar crimp;

FIG. 8B is a front view of a collar crimp;

FIG. 8C is a side view of a collar crimp; and

FIG. 9 is a perspective view of a first end of a strap device.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

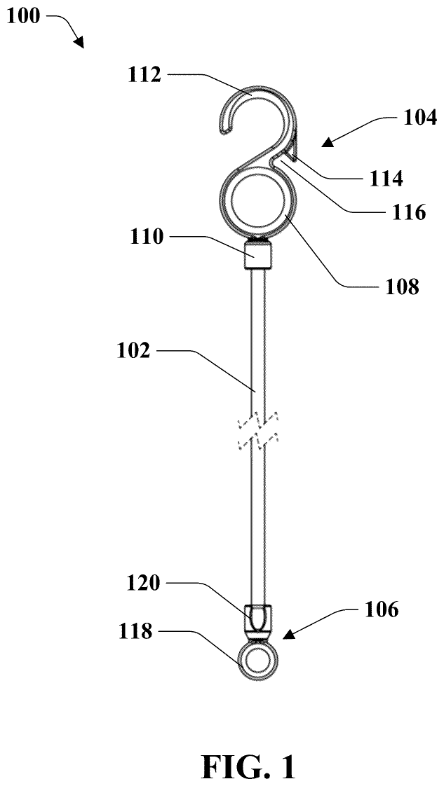

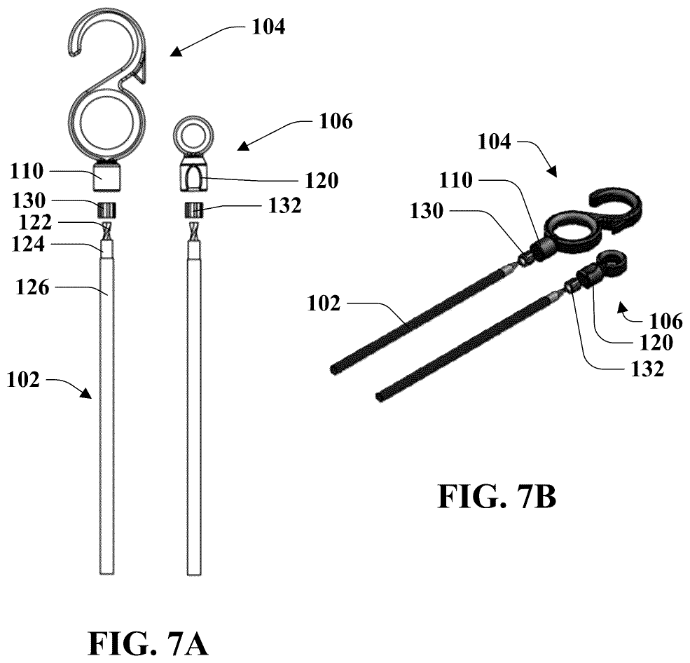

Turning now to FIG. 1, a strap device 100 is shown. The strap device 100 includes a strap 102 having a first end component 104 and a second end component 106. The strap 102 can include a bendable and/or resilient material. The strap 102 can be any length chosen using sound engineering judgment. In one embodiment, the strap 102 is three feet in length. In another embodiment, the strap 102 is six feet in length. The first end component 104 can include a first ring 108. While the first ring 108 is depicted as being circular in shape, it should be appreciated that the first ring 108 can be any shape selected using sound engineering judgment. By way of example, and not limitation, the first ring 108 can be circular, oval-shaped, square-shaped, polygon shaped, among others. A first collar 110 extends from an outer surface of the first ring 108. The strap 102 is coupled to the first end component 104 at the first collar 110 as described in greater detail with respect to FIG. 7A. A hook 112 extends from an outer surface of the first ring 108 at a position opposite from the first collar 110. The hook 112 can include a projection 114 extending from a surface of the hook 112. In one embodiment, the projection 114 extends from the hook 112 at a position proximate to the outer surface of the first ring 108 to create a channel 116 defined by a portion of the outer surface of the first ring 108, a portion of the outer surface of the hook 112, and a portion of the projection 114. In another embodiment, the projection 114 extends from the outside surface of the first ring 108 proximate to the base of the hook 112 to define the channel 116. In one embodiment, the projection 114 can be triangular or wedge-shaped.

The second end component 106 of the strap device 100 includes a second ring 118. While the second ring 118 is depicted as being circular in shape, it should be appreciated that the second ring 118 can be any shape selected using sound engineering judgment. By way of example, and not limitation, the second ring 118 can be circular, oval-shaped, square-shaped, polygon shaped, among others. In certain embodiments, the second ring 118 can be sized such that the second ring 118 can pass through the first ring 108. For example, the second ring 118 can have an outer diameter that is less than the inner diameter of the first ring 108 such that the second ring 118 can pass through the first ring 108. The inner diameter of the second ring 118 can be sized such that the hook 112 can be inserted and fit into the second ring 118. In one example, the inner diameter of the second ring 118 can be larger than a diameter of the hook 112. In another example, the inner diameter of the second ring 118 can be equal to or approximately equal to a diameter of the hook 112. In yet another example, the inner diameter of the second ring 118 can be less than a diameter of the hook 112. In any of the embodiments (and especially in the embodiments where the inner diameter of the second ring 118 is equal to or less than a diameter of the hook 112), the second ring 118 and/or the hook 112 can have a compressible material that allows for the hook 112 to be inserted and fit snugly into the second ring 118. A second collar 120 extends from an outer surface of the second ring 118. The strap 102 is coupled to the second end component 106 at the second collar 120 as described in greater detail with respect to FIG. 7A.

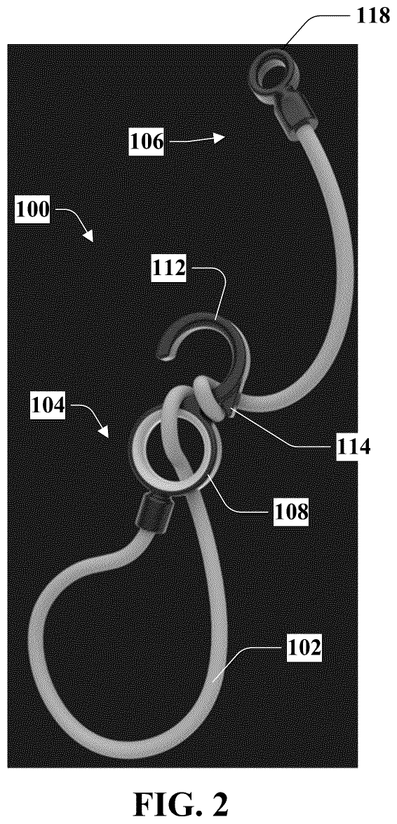

The strap device 100 can secure one or more items in a variety of configurations. The bendable and resilient nature of the strap 102 provides rigidity and strength while wrapped around one or more objects while still allowing the strap 102 to bend into different shapes and configurations. Alternatively, the strap 102 can be a bungee. FIG. 2 depicts one exemplary configuration. A user can wrap or secure the strap 102 around one or more items. The second end component 106 can be passed through the first ring 108 and pulled so that the strap 102 is threaded through the first ring 108. This allows the user to pull the strap 102 tight around the one or more objects. In order to secure the strap device 100, the strap 102 can be wrapped around the first end component 104, including around one or more of the first ring 108 or the hook 112. Further, a portion of the strap 102 can be inserted and secured within the channel 116. In order to accommodate the strap 102 being inserted within the channel 116, the channel 116 can be sized so that the channel 116 has a width configured to receive the strap 102. In one example, the width of the channel 116 is larger than the diameter of the strap 102. In another example, the width of the channel 116 is equal or approximately equal to the diameter of the strap 102. In yet another example, the width of the channel 116 is less than the diameter of the strap 102. In any of the embodiments (and especially in the embodiments where the width of the channel 116 is equal to or less than the diameter of the strap 102), the strap 102 and/or the channel 116 is configured to be compressible to allow for a snug fit of the strap 102 within the channel 116. While secured within the channel 116, the surfaces of the first ring 108, the hook 112, and/or the projection 114 provide friction on the strap 102 to prevent the strap 102 from unwinding and become loose. The surfaces of the ring 108, the hook 112, the projection 114, and/or the strap 102 can include a material that provides a grip. In certain embodiments, the channel 116 can have a depth that is at least equal to the diameter of the strap 102.

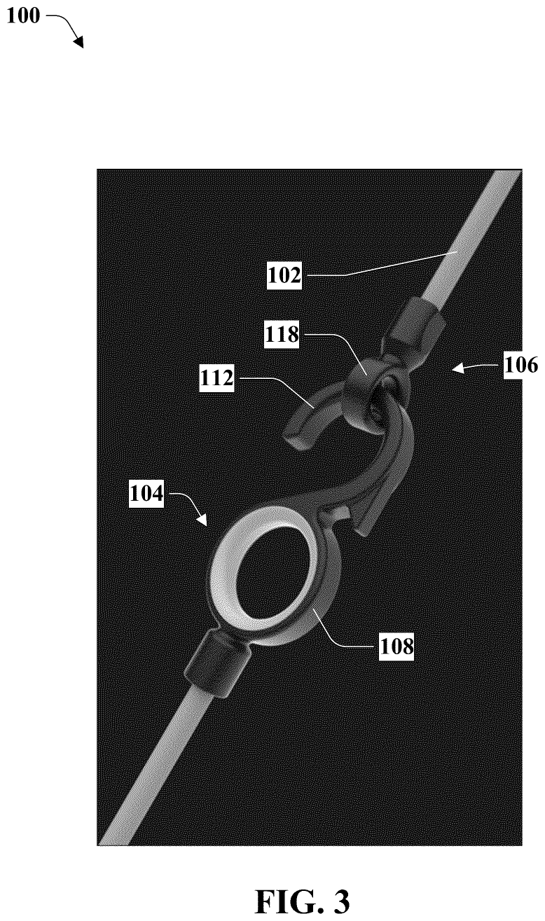

Turning now to FIG. 3, another exemplary configuration is shown. If the length of the strap device 100 needs to be extended, for example, for securing larger objects or larger bundles of objects, the strap device 100 can be daisy chained to another strap device 100. The hook 112 of a first strap device 100 can be inserted into the second ring 118 of a second strap device 100, thereby effectively doubling the usable length of strap devices 100. It should be appreciated that the hook 112 of the first strap device 100 could instead be inserted into the first ring 108 of the second strap device 100, but because the first ring 108 may have a larger diameter than the second ring 118, the hook 112 would not have as snug of a fit within the first ring 108 as compared to the second ring 118. It should also be appreciated that additional strap devices can be daisy chained similarly onto either the first or second strap device 100.

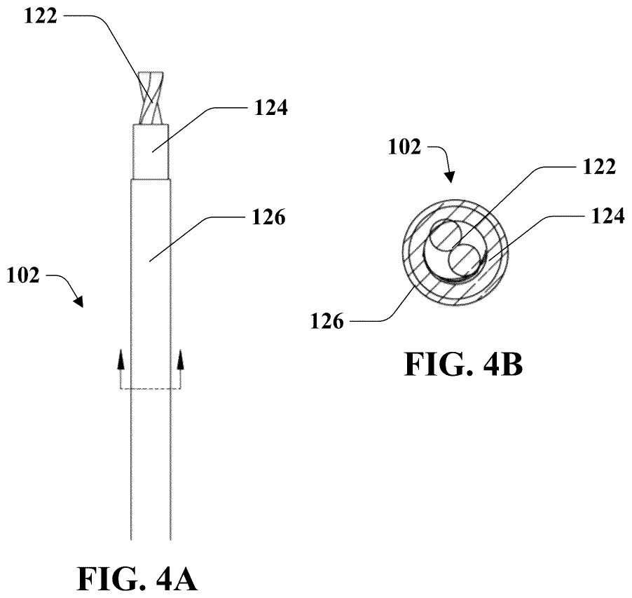

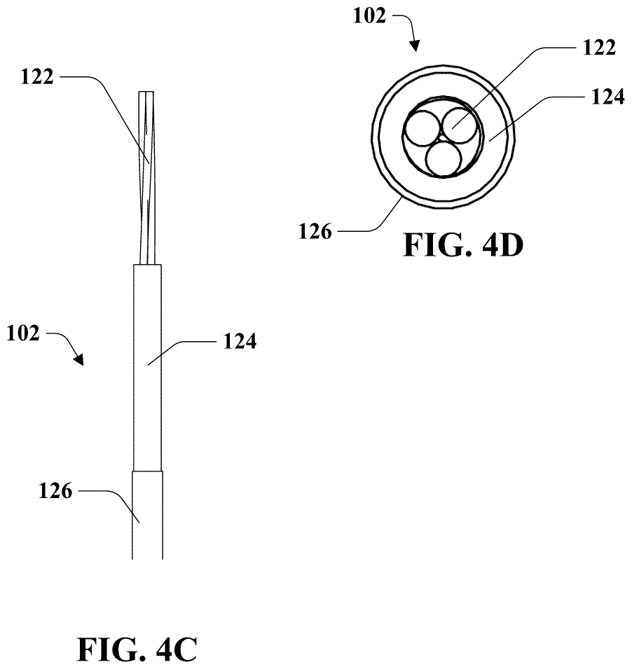

Turning now to FIGS. 4A and 4B, a cross-sectional view of the strap 102 of the strap is shown. The strap 102 includes a core 122. In certain embodiments, the core 122 can be constructed of a metal or an alloy. By way of example and not limitation, the core 122 can be constructed of a carbon steel alloy. The core 122 can include one or more strands. In embodiments with multiple strands, the strands can be wound. When the strands are wound, each of the strands can be wrapped around each other, for example, in a helical arrangement. This arrangement helps to create rigidity, strength, and resilience in the strap 102 while still allowing for bendability. In the embodiment of FIG. 4A, the core 122 includes two strands. Around the core 122, the strap 102 includes an inner sleeve 124. In certain embodiments, the inner sleeve 124 can be made of plastic such as a thermoplastic elastomer (TPE). Around the inner sleeve 124, the strap 102 includes an outer sleeve 126. In certain embodiments, the outer sleeve 126 can be made of a polypropylene textile. The embodiment depicted in FIGS. 4C and 4D is substantially similar to the embodiment in FIGS. 4A and 4B, except that the core 122 in FIGS. 4C and 4D includes three strands instead of two. It should be appreciated that throughout the present description and figures, any embodiment depicted with two strands can also be constructed with one, three, or more strands, and vice versa. The core 122 can be constructed in such a way that the strap 102 is bendable but resilient and can maintain its configuration when bent, shaped, or manipulated by a user.

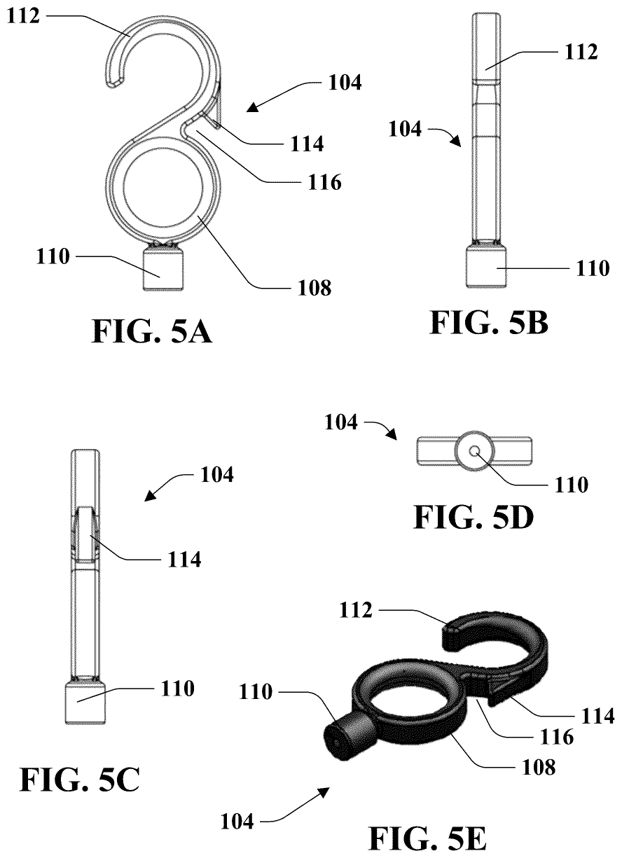

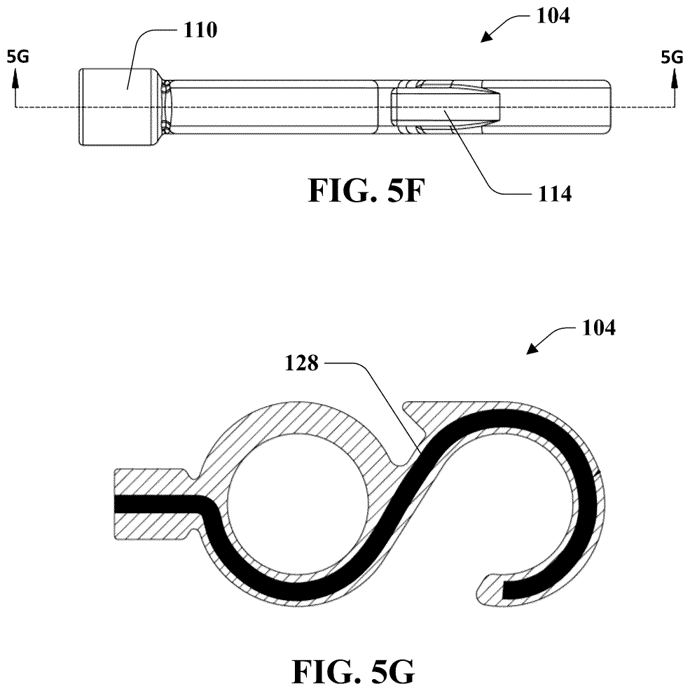

FIGS. 5A through 5G depict an exemplary first end component 104. In certain embodiments, the first end component 104 can be made of glass filled nylon. As shown in FIG. 5G, the first end component 104 can include a steel core 128 within the first end component 104, for example, surrounded by the glass filled nylon.

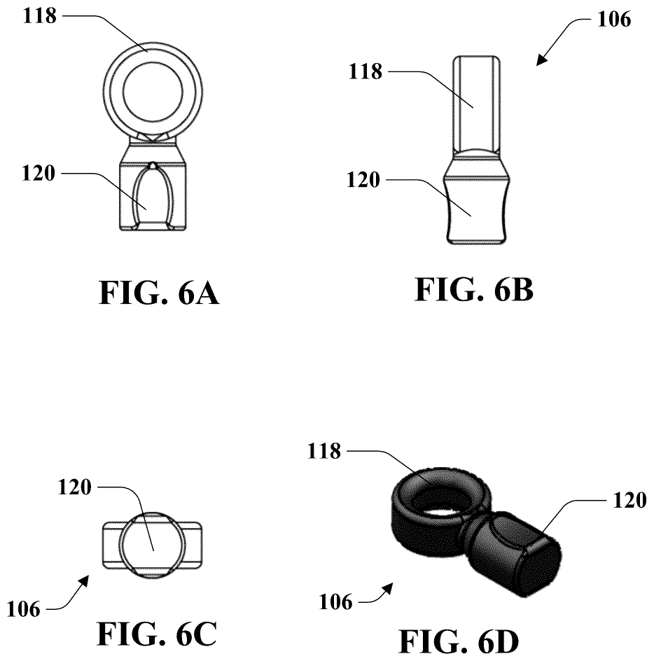

FIGS. 6A through 6D depict an exemplary second end component 106. In certain embodiments, the second end component 106 can be made of glass filled nylon.

Turning now to FIGS. 7A and 7B, an exploded view of the strap device 100 is shown. The strap device 100 can further include a first collar crimp 130 and a second collar crimp 132. In certain embodiments, the first collar crimp 130 and the second collar crimp 132 can be made of a metal such as steel. The strap 102 is inserted into the first collar crimp 130 at its first end, and the first collar crimp 130 is mechanically crimped such that the outer sleeve 126 is mechanically secured to the core 122 at the first end of the strap 102. In certain embodiments, the steel core 128 of the first end component 124 can also be mechanically secured to the core 122 and outer sleeve 126 of the strap 102 with the first collar crimp 130. The first collar 110 is overmolded onto the first collar crimp 130 to secure the strap 102 to the first end component 104.

Similarly, regarding attachment of the second collar crimp 132, the strap 102 is inserted into the second collar crimp 132 at its second end, and the second collar crimp 132 is mechanically crimped such that the outer sleeve 126 is mechanically secured to the core 122 at the second end of the strap 102. The second collar 120 is overmolded onto the second collar crimp 132 to secure the strap 102 to the second end component 106.

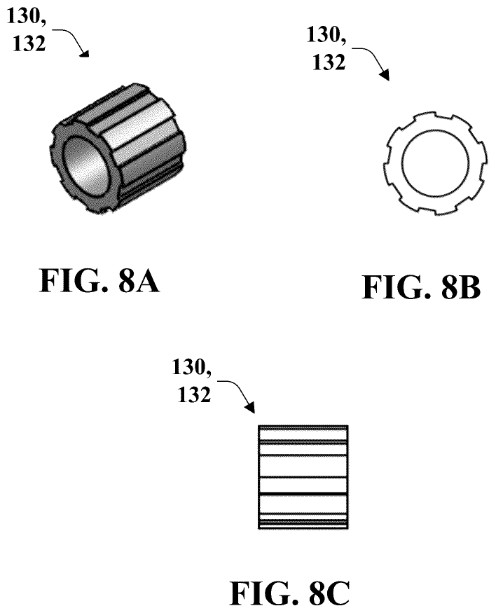

FIGS. 8A through 8C depict an exemplary crimp that can be the first collar crimp 130 or second collar crimp 132. In certain embodiments, the crimp can be made of a metal such as steel. The crimp can also include one or more projections or ridges. The projections or ridges allow for a secure mechanical coupling when the first collar 110 or the second collar 120 is overmolded on the first collar crimp 130 or the second collar crimp 132.

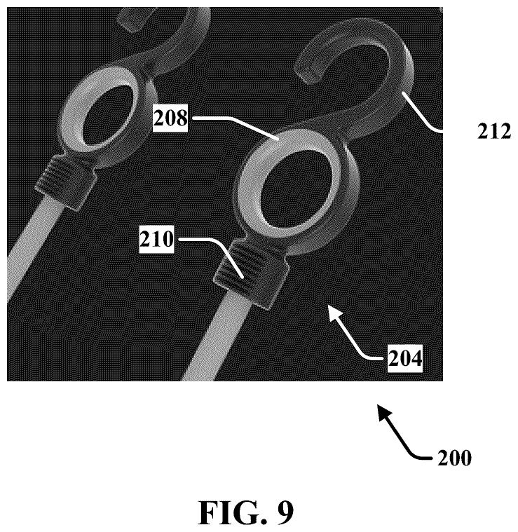

It should be appreciated that in certain embodiments, the strap device 100 can lack a projection 114 and corresponding channel 116. A representative embodiment is depicted in FIG. 9, where a strap device 200 is shown. Strap device 200 is substantially similar to strap device 100, and includes a first end component 204 that includes a first collar 210, a first ring 208, and a hook 212, but does not include a projection or channel. Strap device 100 can include a first end component 204 and a second end component (not shown) or two first end components 204.

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A strap device, comprising:
a strap having a first end and a second end;
a first end component coupled to the first end of the strap, wherein the first end component comprises a first ring, a hook extending from an outer surface of the first ring, and a projection extending from the outer surface of the first ring such that a portion of the projection, a portion of the outer surface of the first ring, and a portion of the outer surface of the hook define a channel; and
a second end component coupled to the second end of the strap, wherein the second end component comprises a second sized such that the second ring can pass through the first ring.

2. The strap device of claim 1, wherein the strap comprises a strap core that includes one or more strands that are wound.

3. The strap device of claim 2, wherein the strap core includes two strands.

4. The strap device of claim 2, wherein the strap core includes three strands.

5. The strap device of claim 2, wherein the strap core is constructed of a carbon steel alloy.

6. The strap device of claim 2, wherein the strap comprises an inner sleeve surrounding the strap core, and an outer sleeve surrounding the inner sleeve.

7. The strap device of claim 6, wherein the inner sleeve is constructed from a plastic material and the outer sleeve is constructed from a polypropylene textile.

8. The strap device of claim 1, wherein the channel is configured to receive the strap.

9. The strap device of claim 1, wherein the second ring has an inner diameter sized to receive the hook within the second ring.

10. The strap device of claim 1, wherein the first end component further comprises a first collar and the second end component further comprises a second collar, and the strap device further comprises:
a first collar crimp mechanically secured at the first end of the strap and a second collar crimp mechanically secured at the second end of the strap, wherein
the first collar is overmolded onto the first collar crimp and the second collar is overmolded onto the second collar crimp.

11. The strap device of claim 1, wherein the first end component further comprises a steel core.

12. The strap device of claim 11, wherein the steel core is surrounded by glass filled nylon.

13. A strap device, comprising:
a strap having a first end and a second end;
a first end component coupled to the first end of the strap, wherein the first end component comprises a first ring and a hook extending from the first ring; and
a second end component coupled to the second end of the strap, wherein the second end component comprises a second ring sized such that the second ring can pass through the first ring.

14. The strap device of claim 13, further comprising:
a projection extending from the hook.

15. The strap device of claim 14, further comprising a channel at least partially defined by the projection.

16. The strap device of claim 15, wherein the channel is arranged to receive the strap.

17. The strap device of claim 13, wherein the strap comprises a strap core constructed of one or more strands.

18. The strap device of claim 17, wherein the one or more strands are constructed of a carbon steel alloy.

19. The strap device of claim 13, wherein the first end component includes a steel core surrounded by glass filled nylon.

20. A strap device, comprising:
a strap having a first end and a second end, wherein the strap includes a strap core comprising two or more wound strands;
a first end component coupled to the first end of the strap, wherein the first end component comprises a first ring, a hook extending from an outer surface of the first ring, and a projection extending from the outer surface of the first ring such that a portion of the projection, a portion of the outer surface of the first ring, and a portion of the outer surface of the hook define a channel; and
a second end component coupled to the second end of the strap, wherein the second end component comprises a second ring, wherein the second ring is sized such that the second ring can pass through the first ring and also receive the hook.
